(19) United States
(12) Patent Application Publication
(10) Pub. No.: US 2015/0080113 A1
(43) Pub. Date: Mar. 19, 2015

(54) ELECTRONIC TRANSACTION ACCESS SYSTEM AND METHOD USING A PLAYER TRACKER CARD

(71) Applicant: GLOBAL CASH ACCESS, INC., LAS VEGAS, NV (US)

(72) Inventors: Scott Yankton, La Mesa, CA (US); Shanna Howatt, La Mesa, CA (US)

(21) Appl. No.: 14/450,542

(22) Filed: Aug. 4, 2014

Related U.S. Application Data
(63) Continuation of application No. 11/208,100, filed on Aug. 18, 2005, now abandoned.

(51) Int. Cl. G07F 17/32

(52) U.S. Cl. CPC G07F 17/3251
USPC 463/25

(57) ABSTRACT

A electronic transaction access system and method using a player tracker card is provided in which a player tracker card issued by a casino may be used as an access device for an electronic transaction. The electronic transaction that may be accessed using the player tracker card may include, for example, an electronic check cashing transaction, a check cashing transaction, a debit transaction, a credit card cash advance transaction or an ATM transaction.

### CROSS-REFERENCE TO RELATED APPLICATIONS

This application is a Continuation of U.S. patent application Ser. No. 11/208,100, filed on Aug. 18, 2005, and incorporated herein by reference.

### FIELD OF THE INVENTION

The invention relates to a financial transaction access system and method.

### BACKGROUND OF THE INVENTION

Player tracker cards that permit a casino to track the gambling of a particular player are well known. Typically, the user is encouraged to use the player tracker card since a casino will offer discounted rooms and other benefits based on the use of the player tracker card. In typical use, the player tracker card is only used to track a user's gaming activities in the casino. However, it would be desirable to provide a method so that the player tracker card may also be used to perform an electronic transaction so that the player tracker card then serves an additional beneficial purpose.

The use of automatic teller machine (ATM) access and/or debit cards is widespread. The ATM cards permit the holder of the card to access an ATM anywhere once the holder of the card enters an access code (sometimes known as a personal identification number (PIN)). A debit card permits the holder to purchase an item and withdraw the money to pay for the item directly from their checking or savings account when an access code is entered. It is desirable to permit a user to access these types of financial transactions using another card, such as a player tracker card.

The use of check cashing services is also well known and widespread. During a check cashing transaction, the person holding a check submits the check (or does so electronically in an electronic check transaction) to an entity that then pays him the amount of the check. It is desirable to permit a user to access these types of financial transactions using another card, such as a player tracker card. Thus, it is desirable to provide an electronic transaction access system and method using a player tracker card and it is to this end that the present invention is directed.

### SUMMARY OF THE INVENTION

An electronic transaction access system and method are provided in which a player tracker card is used to access the electronic transaction. A player tracker card is a card issued by an entity, such as a casino, to track a player's activities/gaming while at the property, such as the casino and then often used for redemption of services within the casino's environment (such as comps, meals, bonuses, hotel stays, gifts, etc.) The player tracker card is typically not used for any other functions. However, in accordance with the invention, the player tracker card may also be used to provide access to an electronic transaction wherein the electronic transaction may be a check cashing transaction, a credit card cash advance transaction, a debit transaction or an automatic teller machine (ATM) transaction. In a preferred embodiment, the electronic transaction is an electronic check cashing transaction. In addition, the electronic transaction access system and method may be used to access a transaction in an establishment/business that is not related to the casino. For example, the player tracker card may be used to conduct a retail POS transaction at a store not connected with the casino that issued the player tracker card so that the casino may generate revenue from the retail POS transaction in accordance with the invention.

The electronic transaction access system and method may include a reader device and financial transaction system. The reader device is able to read a piece of information contained on a player tracker card wherein the information may include access data for a financial transaction. In accordance with the invention, the access data may include one or more of a password, an account number and a personal identification number (PIN.)

### BRIEF DESCRIPTION OF THE DRAWINGS

FIG. 1A is a diagram illustrating a typical player tracker system;

FIG. 1B is a diagram illustrating a player tracker system that includes an electronic transaction access system and method using player tracker card in accordance with the invention;

FIG. 2 is a diagram illustrating a check/card reader device that may be used for the electronic transaction access system and method using player tracker card;

FIG. 3 is a diagram illustrating more details of a player tracker card financial transaction access system in accordance with the invention;

FIG. 4 is a diagram illustrating more details of a preferred embodiment of the electronic transaction system that may be accessed using a player tracker card;

FIGS. 5A-5I are diagrams illustrating several examples of the data contained on a player tracker card that may be used to access an electronic transaction in accordance with the invention; and

FIG. 6 illustrates a player tracker card retail transaction in accordance with the invention.

### DETAILED DESCRIPTION OF THE INVENTION

The invention is particularly applicable to an electronic cash checking transaction that is accessible using a player tracker card and it is in this context that the invention will be described. It will be appreciated, however, that the system and method in accordance with the invention has greater utility since the player tracker card may also be used to access other types of transactions including but not limited to a check cashing transaction, a debit transaction, a credit card cash advance transaction or an ATM transaction. Prior to describing the electronic transaction access system and method using player tracker card in accordance with the invention, a typical player tracker system is described.

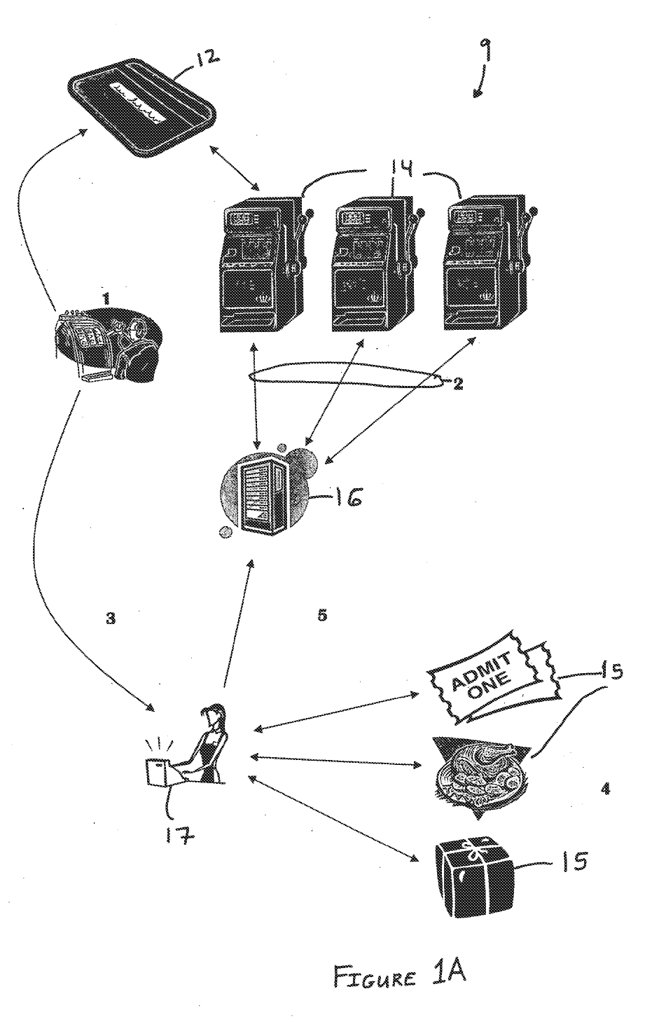

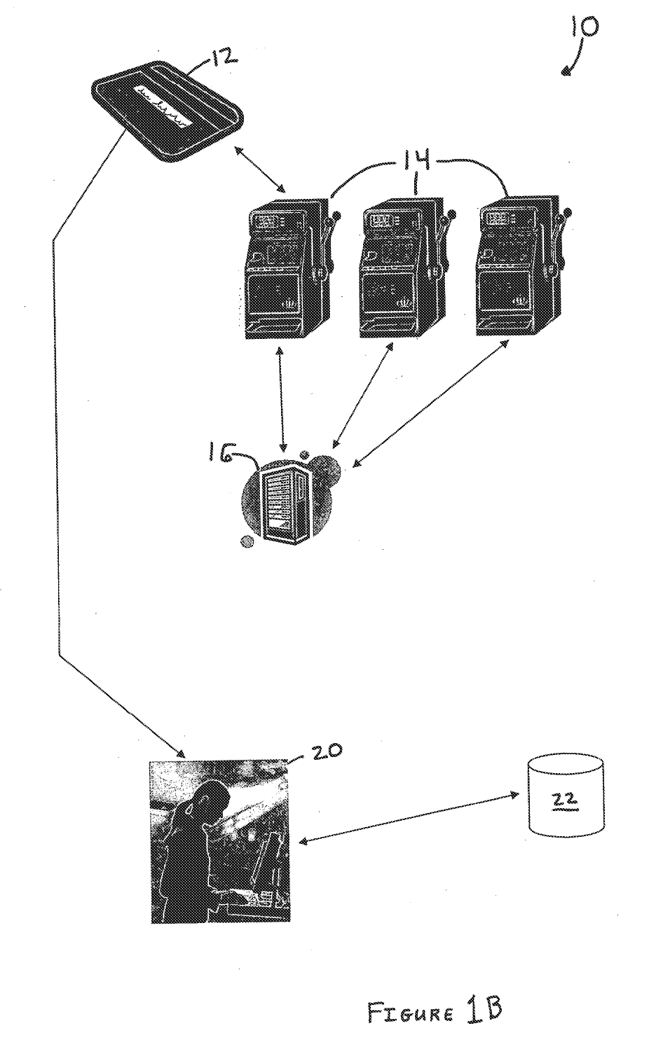

FIG. 1A is a diagram illustrating a typical player tracker system 9. The player tracker system may utilize a player tracking card 12 that has the physical dimensions of a typical credit card that contains data that permits an entity, such as a casino, to track the gaming and activities of a particular player. The player tracker card 12 may be inserted into a slot in a machine 14, gaming table or other revenue producer, such as a slot machine or a various types of gaming tables, so that the casino that houses the machines is able to track the player activities (see step 1), such as time spent using the slot machine, the type of slot machine and the money inserted into the machine. The data from each machine is fed to a player tracking system server 16 (see step 2) and stored in a database for a particular player based on the player identification code contained in the player tracker card. Based on the length of play at the machine or table and the amount of money spent at the table or machine, the player may be awarded player points that are accumulated on the player tracker card and in the player tracker system. In step 3, the player with the player tracker card wants to redeem the points and the player goes to a redemption place, such as a restaurant, box office, etc. In step 4, the player redeems the points for one or more reward items 15. In step 5, the points for the selected reward items are deducted from the player tracking account associated with the player tracker card.

FIG. 1B is a diagram illustrating a player tracker system 10 that includes an electronic transaction access system and method using player tracker card in accordance with the invention. The player tracker system 10 uses some of the same elements as shown in FIG. 1A and those elements have the same reference numbers. In the player tracker system 10, the player tracker card typically contains an identification number that is used by the player tracker system to correlate the play of the machine or table with a player stored in the player tracker system database. When used with the electronic transaction access system and method using player tracker card in accordance with the invention, the identifier contained on the player tracker card is used to provide access to an account of the owner of the player tracker card so that the owner may execute a financial transaction. Thus, as shown in FIG. 1B, the player tracker card 12 may be read at a cashier location 20 in the casino in order to, in a preferred embodiment, execute an electronic check transaction by accessing an eCash system® 22 wherein the access is accomplished using a check reader and a web page.

FIG. 2 is a diagram illustrating a check/card reader device 24 that may be used for the electronic transaction access system and method using player tracker card. In a preferred embodiment, the reader device 24 permits a cashier to swipe a card (and read the data contained on the card such as the data contained on the player tracker card) using a first slot 26 or to scan a check (and read the data on the check) using a second slot 28. An example of a reader device that may be used with the electronic transaction access system and method is a commercially available Magtek® MICR Plus reader device. The reader device is able to read MICR characters on checks, deposit, withdrawal slips and other MICR encoded documents and also has a 3-track MSR (Magnetic Stripe Reader) for ISO and AAMVA card standards. The reader device may be connected to a PIN entry device. The reader device may also have a port, and an auxiliary port available to connect PINpads, barcode readers, or signature capture pads. In a preferred embodiment, the port and auxiliary port may be a universal serial bus (USB) port. However, the port may also be an RS-232 port (such as for the Magtek® MICR Plus reader device described above) or a wireless communications port. More details of this commercially available device is available at http://www.magtek.com/products/check_reading/micr_plus/micr_plus.asp.

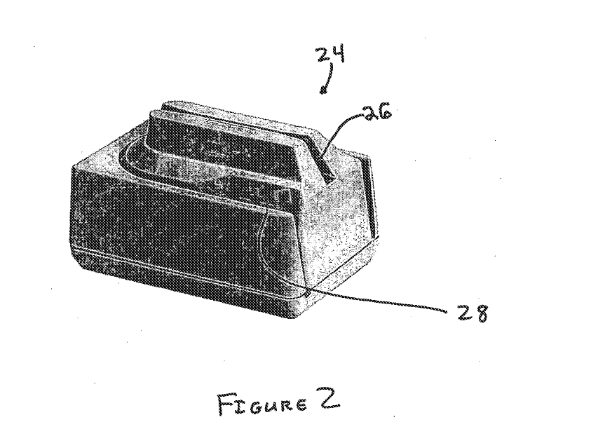

FIG. 3 is a diagram illustrating more details of a player tracker card financial transaction access system 30 in accordance with the invention. As shown, in order to perform an electronic check cashing transaction, the player may either scan a check 31 or swipe the player tracker card 12 using the reader device 24. The reader device 24 is connected to a computer at the cashier's location 20 and the location 20 may also be connected to a PINpad 32. In some cases, such as an ATM transaction, the player is able to input his/her PIN number using the PINpad. In most other transactions, a particular piece of identification of the player with the player tracker card will be used to authenticate the player and permit the financial transaction to continue. In a preferred embodiment, the cashier may check the identification of the player (using an approved ID type) once the player tracker card has been swiped using the reader device. The computer at the cashier's location 20 is connected to the eCash system® 22 that communicates the various data associated with the check cashing transaction onto the eCash systems® 22. The eCash system® 22 may forward some of the information from the cahier onto a Trans Union model system 34 that provides any further information to accomplish the check cashing transaction back to the eCash system® 22. The eCash system® may then approve the amount of the transaction and send the approval back to the cashier location 20. The cashier may then provide an item of value, such as casino chips or cash, to the player based on the approved transaction. The eCash system® 22 may also then perform the settlement of the check cashing transaction by performing either a settlement 36 by an automated clearing house (ACH) transaction or a settlement 38 via traditional physical deposit to a bank 40 that in turn settles the check cashing transaction with a bank 42 of the player.

FIG. 4 is a diagram illustrating more details of the preferred embodiment of the electronic transaction system that may be accessed using a player tracker card. The electronic transaction system may be accessed to perform a check cashing transaction 50 from the cashier location 20 or to perform a credit card transaction 52 or a debit POS transaction 54 at a bank kiosk 60 wherein the data is routed to the eCash systems® 22. The electronic transaction system may be accessed to perform a credit transaction 52, a debit transaction 54 or an ATM transaction 56 from a multiple function ATM 62 or to perform an ATM transaction 56 from an ATM 64 wherein the data from these transactions is routed to an ATM system 66 located within the bank 40 that also houses the eCash system® 22. As shown, the eCash system® 22 and the ATM system 66 are coupled to each other and communicate data between the two systems. As shown, the eCash system® 22 is may communicate the credit transaction data and the debit transaction data between a payment processing system 68 and the eCash system® 22. The payment processing system 68 may be coupled to a bank 70 that issued the credit card and may communicate the data between the bank and the payment processing system 68. The ATM system 66 may be coupled to an ATM network 72 and communicate the debit and ATM transaction data between the ATM system 66 and the network 72. The ATM network 72 may in turn be coupled to a bank 74 that issued the ATM card and one or more other ATM networks 76. In one embodiment, the primary ATM network 72 may be the STAR network whole the other ATM networks may include Plus, Cirrus, etc. The other ATM networks 76 may be connected to a bank 78 that issued the ATM card for that network. As shown, the debit and ATM transaction data may be communicated between these various elements in a known manner since the various financial transactions shown in FIG. 4 are well known and understood by one of ordinary skill in the art.

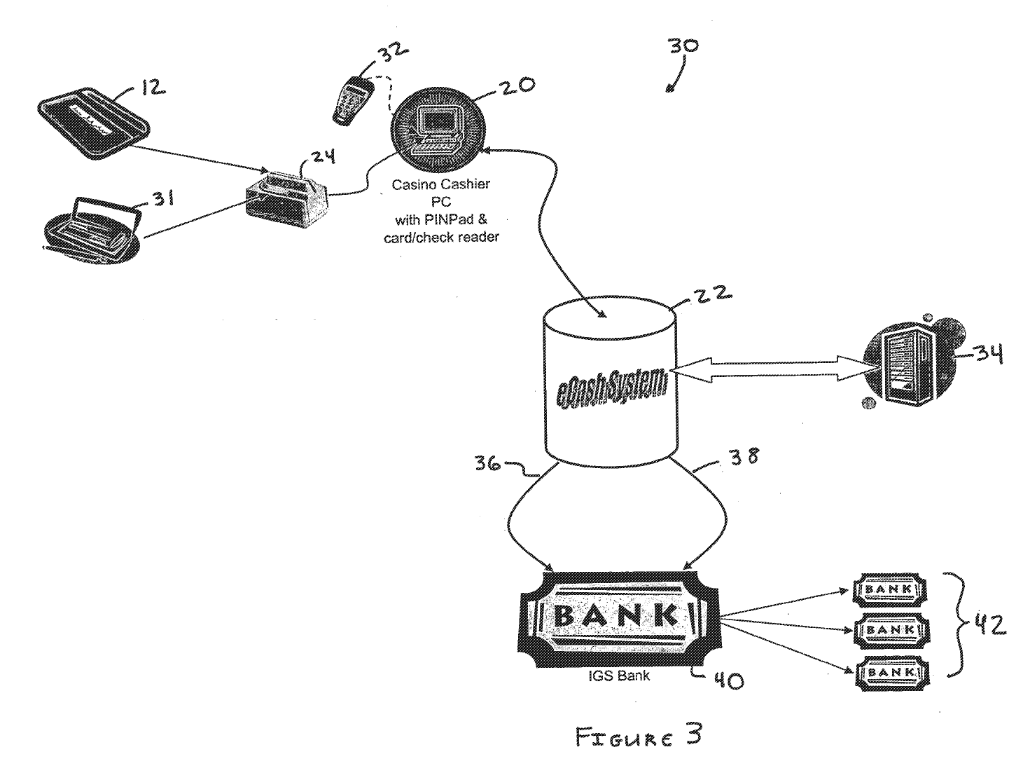

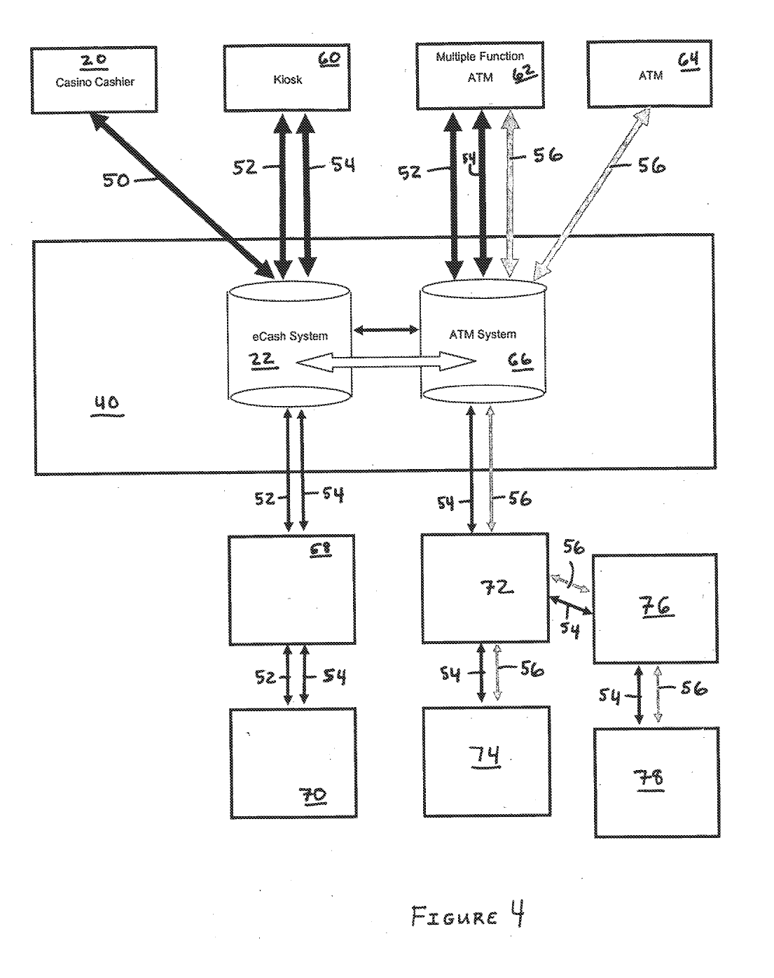

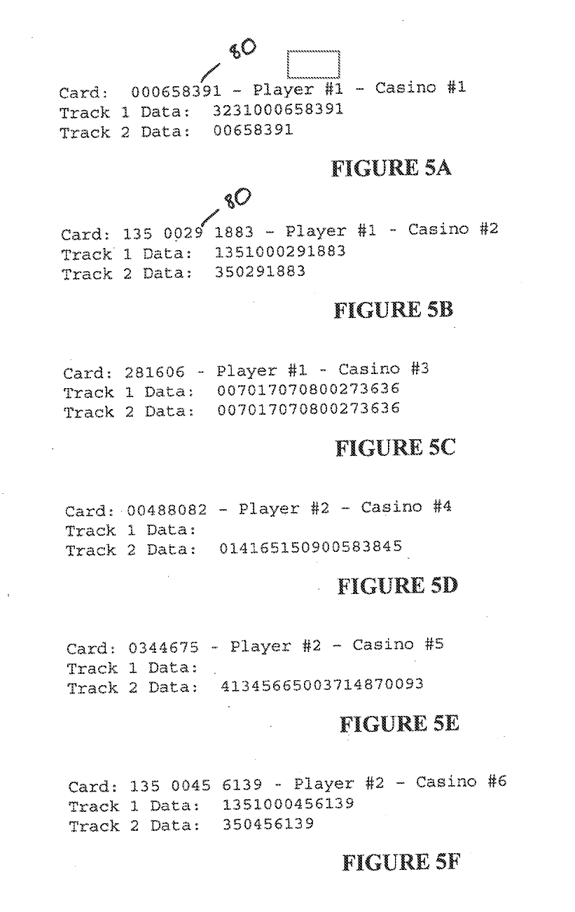

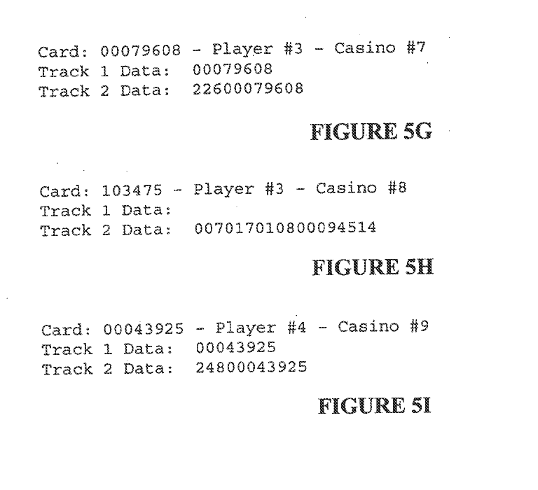

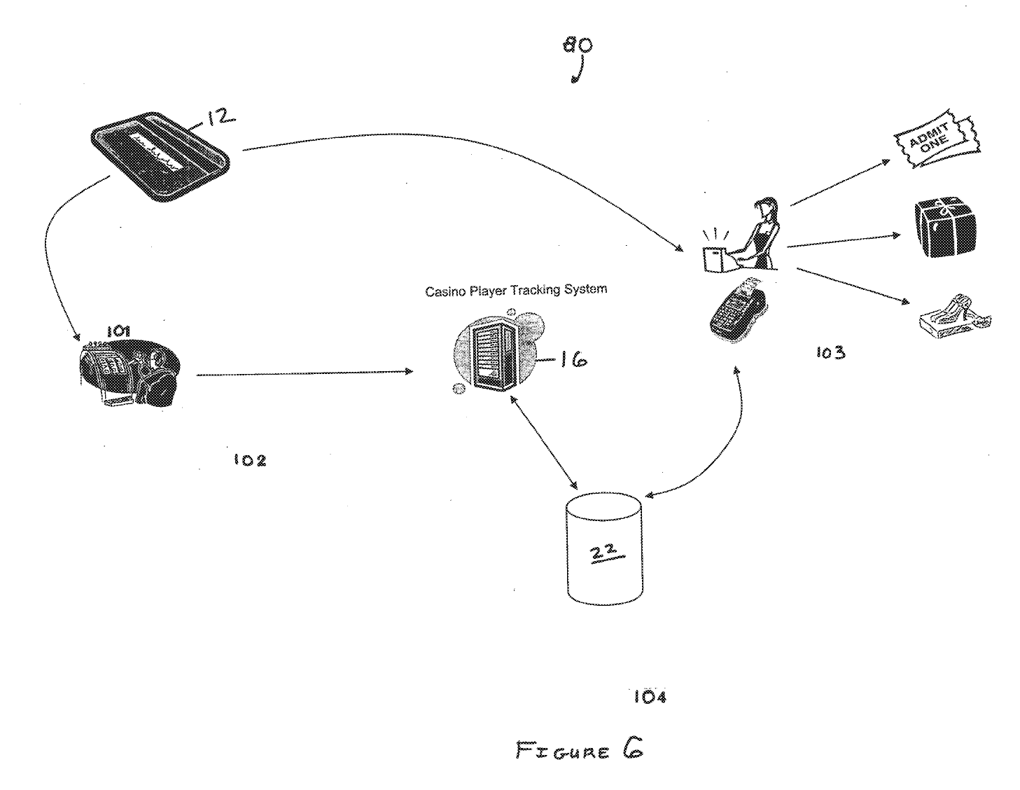

FIGS. 5A-5I are diagrams illustrating several examples of the data contained on a player tracker card that may be used to access an electronic transaction in accordance with the invention. As shown in FIG. 5A-5I, each different casino may have different data stored on the player tracker card. Typically, the player tracker card has a first track and a second track and the actual data stored in these tracks depending on the particular casino. On some player tracker cards, the data in at least one track is the same as the player tracker identifier 80. In any event, the electronic transaction system that may be accessed using a player tracker card is able to use the data contained on the player tracker card to identify the player which can then be used to accomplish a check cashing transaction. In some situations, other data from the player, such as an identification or a PIN, is entered into the system. The player tracker card may also contain a site/casino identifier to identify the casino that issued the player tracker card in case the account numbers on the player tracker cards for different sites/casinos overlap each other.

FIG. 6 illustrates a player tracker card retail transaction system 80 in accordance with the invention since the electronic transaction system using a player tracker card may also be used to conduct a point of sale transaction. A point of sale (POS) transaction is typically for retail purchases that occur outside of the casino and maybe a third party. This embodiment of the electronic transaction system using a player tracker card contains some of the same elements shown in FIGS. 1A and 1B and those elements have the same reference numbers and operate in the same manner unless indicated otherwise. As with the player tracker system described above, the player may play slots, table games or other revenue producers in step 101 and the player accumulated points for those activities that may be sent to the player tracker system 16 in step 102. In step 103, the player may use the player tracker card for purchases, such as at a participating retail store. The store at which the purchase occurs may be on the casino/site property or it may also be outside of the casino/site so that the player tracker card may enable a casino owner or the like to derive revenue from activities that have occurred outside of the casino. At the store, the player tracker card is swiped at a POS terminal at the store wherein the player tracker card provides access to the eCash system® 22. Typically, a cashier at the store may check an ID of the player prior to authorizing the purchase. In step 104, the eCash system® 22 has an interface with the player tracker system 16 so that points may be deducted from the player's points when the player tracker card is used for retail purchases. The value to a casino/site of this embodiment is that is differentiates the casino from other casinos since it permits use of the player tracker card outside of the casino property. The casino/site may also generate some revenue due to the discounted repayment of the participating retailers.

In accordance with the invention, the electronic transaction system using the player tracker card does not require that a PIN is used for each type of transaction. However, it is understood that the PIN may be used. In most cases, the system may instead require an identification check of the player that holds the player tracking card wherein the identification check is performed by the cashier/retail store clerk when a transaction using the player tracker card occurs.

While the foregoing has been with reference to a particular embodiment of the invention, it will be appreciated by those skilled in the art that changes in this embodiment may be made without departing from the principles and spirit of the invention, the scope of which is defined by the appended claims.

Although the present invention has been described with reference to preferred embodiments, workers skilled in the art will recognize that changes can be made in form and detail without departing from the spirit and scope of the present invention.

What is claimed is:

1. A system for accessing an electronic transaction, comprising:
a reader device that reads a piece of information contained on a player tracker card, the piece of information including a piece of access data for a financial transaction, the reader device located at a cashier's location of a casino; and
a financial transaction system that performs a financial transaction using an account wherein the financial transaction is authorized by the piece of access data contained on the player tracker card.

2. The system of claim 1, wherein the financial transaction is an electronic check cashing transaction.

3. The system of claim 1, wherein the financial transaction is a credit card cash advance transaction.

4. The system of claim 1, wherein the financial transaction is a debit transaction.

5. The system of claim 1, wherein the financial transaction further comprises an automatic teller machine transaction.

6. The system of claim 1, wherein the piece of access data further comprises an account number.

7. The system of claim 1, wherein the financial transaction system further comprises an entry pad wherein a personal identification number is entered into the entry pad in order to authorize the financial transaction.

8. The system of claim 1, wherein the reader device further comprises a player tracking card reader and a check reader.

9. The system of claim 8, wherein the financial transaction may be authorized based on the scanning of a check by the check reader.

10. A method for performing a financial transaction, comprising:
reading a piece of data from a player tracker card at a location of a cashier;
determining an identity of the player based on the data contained on the player tracker card;
executing a financial transaction at the location of the cashier based on the data contained on the player tracker card; and
providing at item of value to the player based on the executed financial transaction.

11. The method of claim 10, wherein the financial transaction is an electronic check cashing transaction.

12. The method of claim 10, wherein the financial transaction is a credit card cash advance transaction.

13. The method of claim 10, wherein the financial transaction is a debit transaction.

14. The method of claim 10, wherein the financial transaction further comprises an automatic teller machine transaction.

15. The method of claim 10, wherein the piece of data further comprises an account number.

16. The method of claim 10, wherein executing the financial transaction further comprises receiving a personal identification number from the user to authorize the financial transaction.

17. The method of claim 10, wherein executing the financial transaction further comprises checking an identification of the user prior to authorizing the financial transaction.

18. The method of claim 10, wherein the item of value further comprises cash.

19. The method of claim 10, wherein the item of value further comprises chips.

20. A system for accessing an electronic transaction, comprising:
a reader device that reads a piece of information contained on a player tracker card, the piece of information including a piece of access data for a financial transaction, the reader device being located at a location outside of a casino that issued the player tracker card; and
a financial transaction system that performs a financial transaction using an account wherein the financial transaction is authorized by the piece of access data contained on the player tracker card wherein the financial transaction is a retail purchase that occurs outside of the casino.

21. The system of claim 20, wherein the piece of access data further comprises an account number.

22. The system of claim 20, wherein the financial transaction system further comprises an entry pad wherein a personal identification number is entered into the entry pad in order to authorize the financial transaction.

23. The system of claim 20, wherein the reader device further comprises a player tracking card reader and a check reader.

24. The system of claim 20 further comprising a player tracking system with a database containing a player record wherein the player record is associated with the player tracker card and wherein the player record has a plurality of points attributed to the player based on activities in the casino and wherein the financial transaction system is coupled to the player tracking system so that points are deducted from the player record based on the retail purchase.
